(19) United States
(12) Patent Application Publication
(10) Pub. No.: US 2010/0316176 A1
(43) Pub. Date: Dec. 16, 2010

(54) SYSTEM AND METHOD FOR REMOTELY-INDUCIBLE VARIABLE-ELEMENT ELECTRO-CHEMICAL-NUCLEAR DISRUPTION

(76) Inventor: Mark A. Wood, Orlando, FL (US)

Correspondence Address: BEUSSE WOLTER SANKS MORA & MAIRE, P. A., 390 NORTH ORANGE AVENUE, SUITE 2500, ORLANDO, FL, 32801, US

(21) Appl. No.: 12/483,377

(22) Filed: Jun. 12, 2009

(51) Int. Cl. G21G 1/10

(52) U.S. Cl. 376/190

(57) ABSTRACT

A system for remotely-inducing variable-element electro-chemical-nuclear disruption, the system including an energy delivery device that emits a frequency-adjustable electromagnetic non-photonic continuous-wave beam, and a target area located a distance from the energy delivery device with which the continuous-wave electromagnetic beam interacts wherein the energy delivery device accelerates one or more charged particles or ions within the energy delivery device as a charge antenna.

### BACKGROUND OF THE INVENTION

The present invention relates in general to the field of nuclear physics and nuclear chemistry, and more particularly, to a system and method for providing for a high yield per unit of reactive mass in both a contained energy release and an uncontained energy release to obtain optimum energy states.

Nuclear fission has been observed as one of the decay modes of radioactive isotopes. Radioactive decay by naturally occurring radioactive elements has been used for much of the twentieth century for medical, industrial, electrical-production and destructive purposes. In each case, the naturally existing tendency of radioactively unstable isotopes to randomly but predictably decay has been utilized towards the ends desired. Various methods to increase the functional optimization of the radioactively unstable isotopes have included external irradiation and isotope-sorting, such as by centrifuge enrichment or by using free-electron lasers tuned to differentiate between the electron energy levels of the various isotopes, such as U235 versus U238. Additionally, size-and-weight-sensitive energetic applications have utilized a variety of secondary materials to optimize reactive conditions for maximized output efficiency.

To date, the only publicly-known way to induce nuclear decomposition in isotopes that are naturally stable is to destabilize them by external bombardment in a process that is energetically costly compared to the energy released, rendering this method non-viable for controlled-reaction-power-production.

Simple fission reactions release comparatively little energy per unit of mass compared to the total amount of energy that is contained within that mass, such that an optimal fission reaction yields approximately 1/1000 of the mass-energy of the fissioning material with practical results often a smaller fraction of that yield.

Other means of obtaining increased yield per unit of reactive mass have only been viable for uncontained energy releases that generally have required large-scale-fission-reactions to provide the initial energy to attain optimum energy states. The use of fusion reactions for controlled energy production has not yet achieved a positive net result in any of the existing plasma-compressing reactors. More energetic reactions, such as anti-particle-annihilation, have been confined to physics experiments operating at the individual particle scale with no bulk operation potential yet known.

No system or theory publicly known exists as of this date to directly induce nuclear disintegration, hadronic disintegration and/or total matter-to-energy conversion.

### BRIEF DESCRIPTION OF THE INVENTION

Embodiments of the present invention relate to a system and method for remotely-inducing variable-element electro-chemical-nuclear disruption. The system includes an energy delivery device that emits a frequency-adjustable electromagnetic non-photonic continuous-wave beam, and a target area located a distance from the energy delivery device with which the continuous-wave electromagnetic beam interacts. The energy delivery device accelerates one or more charged particles or ions within the energy delivery device as a charge antenna.

The method includes inducing a nuclear vibrational decomposition via sustained energy delivery using a laser-like device at an isotope-specific frequency or frequency-pattern that is delivered by a continuous-wave beam to a target material at an intersection point.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 depicts an exemplary embodiment of a device for providing sustained vibrational resonant disruption applied to atomic nuclei by rapid traversal of ions through an alternating field pathway;

FIG. 2 depicts, in block diagram form, an exemplary embodiment of a device for providing sustained vibrational resonant disruption applied to atomic nuclei by directly applying high-frequency sustained electro-magnetic emissions to a target atomic nuclei, using a single emitter, through a non-reactive pathway;

FIG. 3 depicts an exemplary embodiment of a Trapped-Charge-Continuous-Wave-Energy-Emitter (TCCWEE);

FIG. 4 depicts an exemplary embodiment of a simplified electrical generation system using a single TCCWEE to create a thermal input from a fixed target for a steam-turbine loop;

FIG. 5 depicts a block diagram of an exemplary embodiment of a device for providing sustained vibrational resonant disruption applied to atomic nuclei by directly applying high-frequency sustained electro-magnetic emissions to a target atomic nuclei, from multiple emitters;

FIG. 6 depicts an exemplary embodiment of a simplified electrical generation system using two intersecting TCCWEE's to create a thermal input within a fluid medium of a steam-turbine loop;

FIG. 7 depicts an exemplary embodiment of a simplified propulsion system using two intersecting TCCWEE's to create the thermal output for exhaust-gas expansion and thrust; and

FIG. 8 depicts a flowchart illustrating an exemplary embodiment of a method for remotely-inducing variable-element electro-chemical-nuclear disruption.

### DETAILED DESCRIPTION OF THE INVENTION

Exemplary embodiments of the present invention employ sustained vibrational resonant disruption applied to atomic nuclei by rapid traversal of ions through an alternating field pathway and/or by directly applying high-frequency sustained electro-magnetic emissions to the target atomic nuclei. As illustrated in FIG. 1, utilizing a charged-ion accelerator device 10 is provided that vents high-speed ions in a stream 11 into a reaction-inducing-pathway, or chamber 12, lined with alternating-direction electric field emitters 13 (similar to the configuration of “wiggler” magnets used in a free-electron-laser) where an induced vibrational frequency is largely controlled by the speed of traversal of the ions through the reaction-pathway. Energy capture is accomplished by positioning a thermal-transfer target 14 (such as but not limited to a gold-loaded carbon-nanotube tiled radiation-to-electricity converter) just beyond a point 15 of expected nuclear decomposition on the axis of the ion-flow of the reaction pathway 12.

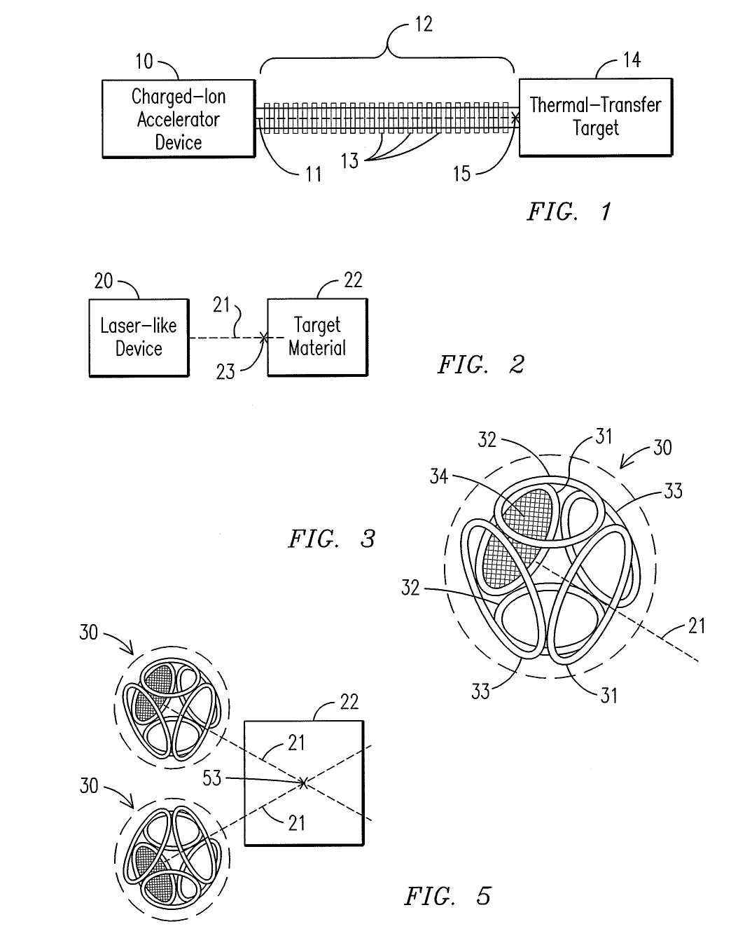

Alternatively, as illustrated in FIG. 2, a nuclear-decomposition reaction is accomplished by remotely inducing a nuclear vibrational decomposition via sustained energy delivery using a laser-like device 20 at an isotope-specific frequency or frequency-pattern, delivered by a continuous-wave beam 21 to a target material 22 at an intersection point 23. Both the laser-like device and the charged-ion accelerator device may be generally referred to as an energy delivery device. To achieve tunable frequencies, the laser-like device 20 may be similar to a free-electron-laser in that it achieves directed-energy output without utilizing electrons in atomic orbitals that emit discrete photons whenever the electrons drop to a lower orbit shell, but to create the sustained continuous-wave emission required for vibrational synchronization at the target material 22, the laser-like device 20 may have characteristics similar to an antenna. Therefore, the laser-like device 20 uses one or more charged particles or ions, trapped within a containment device 30, as illustrated in FIG. 3 and discussed in further detail below, that is rapidly vibrated by manipulating opposing containment fields or closely adjacent charge-plates.

The containment device 30 may be referred to as a Trapped-Charge-Continuous-Wave-Energy-Emitter 30 or simply an emitter 30, and abbreviated as TCCWEE. Structurally, the TCCWEE 30 is likely to have a form of a cube, icosahedron, or dodecahedron with opposing faces, generally open faces, defined by wire-wound coils significantly similar to a Bussard polywell containment chamber, but with independent oscillation control over each pair of opposing faces 31, 32, 33. For example, an exemplary form is a six sided or more polyhedral compound structure having opposing faces. An alternative embodiment of the emitter could instead use a non-reactive near-linear structural containment system for the ions to be cyclically oscillated (or producing cyclical movements), ideally comprised of a multitude of parallel, capped, long, carbon nanotubes each containing a single trapped ion, with oscillation-impelling field emitters positioned surrounding the parallel-nanotube-cluster. Those skilled in the art will recognize that emitter 30 may be representative of either embodiment, or any number of embodiments.

Whereas a Free-Electron Laser creates a frequency-adjustable photon stream by flowing high-speed electrons past a series of wiggler-fields to induce localized charge-acceleration that launches photons along the line of travel of the electron flow, the TCCWEE 30 holds one or many charges (electrons or ions) as a miniature trapped-charge antenna, and/or an oscillated-charge antenna, within a set of containment fields generated by wound-wire coils 31,32,33 with the emitter 32 fractionally intensity-oscillated to vibrate the trapped ions and a stable but steerable (and/or controllable), such as but not limited to electronically steerable, additional charge grid 34 or field emitter positioned along one output axis-ring 31 or on one side of the TCCWEE's vacuum-chamber containment apparatus 35 to longitudinally bias and steer the generated electromagnetic continuous wave along a chosen emission beam 21.

The TCCWEE 30 comprises two output axis containment field generators or rings 31, facing each other. Two vertical axis containment field generators or rings 32, facing each other are also provided. The vertical axis containment field generators 32 may be used for principal oscillation. Additionally, two lateral axis containment field generators or rings 33, facing each other, are also provided. The TCCWEE 30 is located within a vacuum chamber 35, also disclosed as the containment apparatus. The output-axis containment rings 31 and lateral axis containment rings 33 charge intensity and field fluctuation frequency may be used to steer the beam emission 21 while the vertical oscillation rate will drive the output wave frequency. To control directional output from the emitter 30, an appropriate biasing field, or charge-grid 34, is provided opposite and/or orthogonal to a direction of a desired emission.

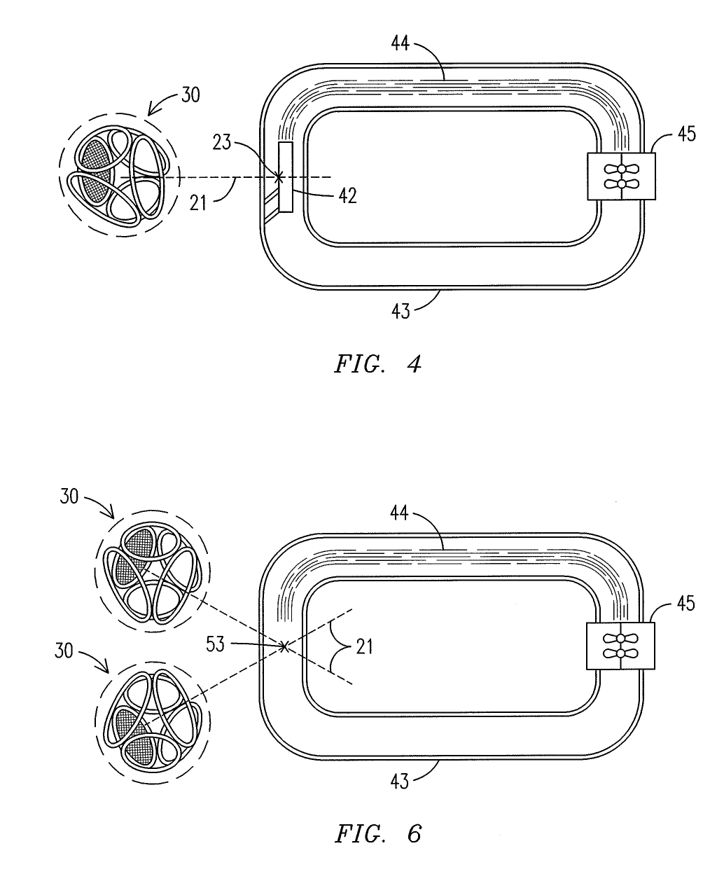

Turning back to FIGS. 1 and 2, energy capture, if desired, can be accomplished by triggering vibrational nuclear decomposition for a target material within a radiation-to-electricity conversion pathway, or chamber, 14, 22 such as a chamber utilizing layers of carbon nano-tubes packed with gold. Alternatively, energy transfer can use a more traditional thermal energy transfer system as shown in FIG. 4.

As illustrated in FIG. 4 the TCCWEE 30 is used to produce a continuous-wave beam 21 tuned to the resonant nuclear disruptive frequency of a target material 42, such as, but not limited to, a common material including iron and/or silicate rock, a material to be disposed, including radioactive leftovers from U235 reactors such as Cesium or Iodine. Those skilled in the art will readily recognize other suitable examples of target material. For example, the target material may actually be a target isotope. In an exemplary embodiment, the target material 42 is suspended midway in a pipe 43 that forms a water-steam-turbine loop which transfers energy resulting from the nuclear disruption of target material 42 at the simple-intersection point 23 by beam 21 from emitter 30, predominantly in a form of heat to the surrounding water. The resulting steam 44 then drives a turbine 45. By suspending the target material away from the pipe walls minimizes damage from the decomposition process continuously occurring directly adjacent to the pipe 43, but some atoms thrown off of the target during sustained operations would inevitably drift near to the pipe walls 43, intersect the conversion beam 21 and nuclear-disintegrate, releasing heat, thus cause unwanted and unsustainable thermal structural damage.

The continuous-wave beam 21 emitted from the TCCWEE 30 will trigger decomposition events in a first isotope of the target material 42 of FIG. 4 that it encounters linearly from the emitter 30, which may not always be a desired effect. An exemplary solution to this undesired effect is shown in FIG. 5. Two or more TCCWEE emitters 30 are used, each firing continuous-wave beams 21, tuned so that neither beam 21 is reactive with the intervening medium but that the cumulative electromagnetic interference pattern at their multi-beam-intersection point 53 appropriately matches, and/or aggregates, an intended resonant frequency pattern of the target isotope or particle type of the target within region 23. Those skilled in the art will recognize that it may also be possible to bias the pattern, type, and direction of the energy and particulate output of nuclear decomposition by manipulating the energy and material environment in which the decomposition takes place. Similarly, a generically tuned continuous-wave-beam (i.e. to the destructive resonant frequency of protons) could operate effectively only upon a continuously exo-atmospheric pathway to its target, and would have to be either tuned to a specific nuclear resonant destructive frequency (i.e. copper) or would have to use a dual-TCCWEE emitter system with beam-frequencies that are non-reactive to the medium using intersection-interference for the desired effect at the target.

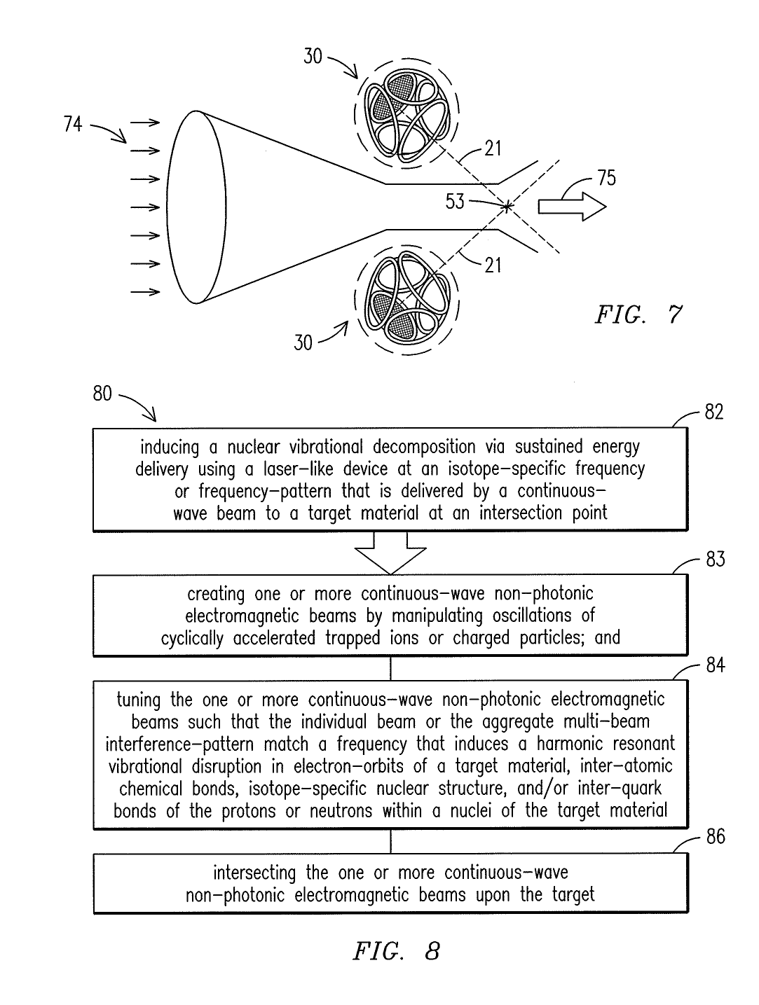

FIG. 6 depicts a dual emitter configuration used with the thermal transfer system depicted in FIG. 4. Modifying the exemplary embodiment depicted in FIG. 4, the dual-emitter system of FIG. 5 would not need to utilize the target material 42 to minimize structural damage to the thermal-transfer-system, but instead the two beams 21 would intersect at point 53 in a middle of the reinforced pipe or chamber 43 with the electromagnetic interference pattern between the frequencies of the beams 21 matching either the nuclear disruptive frequencies of protons or the nuclei of either hydrogen, oxygen, other additives intentionally dissolved in the water. This results in inducing nuclear decomposition in a predefined location where damaging of the chamber 43 is minimized. The resulting superheated water and steam 44 would then proceed to drive the steam turbines 45. Those skilled in the art will recognize that the target isotope is the chemicals found in the water.

Another exemplary use of the two emitter system is in a propulsion system. An exemplary embodiment of using at least two emitters is illustrated in FIG. 7. FIG. 7 depicts a simplified propulsion system. Using two TCCWEE's 30 aimed to intersect continuous-wave beams 21 at point 53 in an intake-flow-material and/or a target isotope 74, creates a nuclear-disruptive superheated thermal output for exhaust gas 75 expansion and thrust. Those skilled in the art will also recognize that FIG. 7 may represent a heat-transfer portion of a rocket output nozzle utilizing self-carried-reaction-mass as the intake-flow material, or more generally, a thermal expansion propulsion system.

As further illustrated in FIGS. 5, 6 and 7, for normal utilization of an exemplary embodiment of the invention, two TCCWEE's 30 are utilized, each capable of vibrational oscillation frequencies ranging from Ultra-Violet for normal ionization up to extreme gamma frequencies to destabilize hadrons. By using dual emitters 30, it is possible to have singular or coordinated emissions for linear-path disruption, such as illustrated in FIG. 2, or beam-intersection-point-only targeted-disruption, such as illustrated in FIGS. 5, 6 and 7.

By maintaining a continuous wave output rather than separated, randomly-timed photonic packets, this configuration ensures sustained vibrational synchronization, steadily amplifying a vibrational amplitude of a target 53, rather than randomizing vibrational oscillatory input as a randomly-timed photonic transmission from a solid-state, gas or a free-electron laser system would. This is especially important since non-simple patterns of induced oscillation may be required to induce breakup of various nuclear structure forms.

An alternate use for intersection-targeted nuclear decomposition would be for non-localized demolition, such as if a terrestrial structure must be destroyed from an aircraft or spacecraft (or vice versa), where this capability may be uniquely helpful for the elimination of orbiting space debris following satellite launches or collisions.

Additionally, the wide frequency range envisioned for the emitters allows significant control of the results at the target, varying from inducing thermal flux to electrical discharge to chemical-bond disruption to nuclear fission, to nuclear disruption to hadronic fission. This allows the same TCCWEE's to have less-than-destructive effects when necessary, or a combination of destructive and non-destructive effects, such as when circumstances dictate that distant biological or technological targets experience electrical or chemical interference, such as remotely inducing a neural impulse cascade to non-lethally immobilize one or more people, or weakening the rebar within the concrete of a structure, leaving no trace of internal damage. Oppositely, a vehicle could be selectively disabled without destruction, such that the device could induce material-damage or electrical-surge subsystem malfunctions in radar, avionics, etc., in a target that required unprovable or deniable nondestructive discouragement from its course of action.

Similarly, the penetrative specificity of an exemplary embodiment of the invention would mean that one could, by sufficient emitter amplitude, induce nuclear breakdown, or electrical or chemical disruption in protected or underground targets, such as a concentration of Plutonium buried under layers of metal, concrete and dirt, and with care, disruption can be achieved without inducing secondary reactions, rendering a stored warhead insert without externally detectable damage. Similarly, biological or technological objects could be targeted through barrier materials or structures. If rapidly moving objects are difficult to pinpoint with a multi-emitter system, the use of a single emitter tuned to a known onboard material would optimize interception chances, especially if the known material were unstable already, such as a radioactively unstable isotope like Plutonium or Uranium, or a known specific chemical such as C4 or RDX (for ICBM or cruise-missile warhead interception where a strongly exothermic chemical reaction or disruption will mission-kill the warhead without detonating it). For applications where there is insufficient intervening atmosphere to attenuate a non-specific beam, the emitters can be tuned to induce generalized disruption by targeting the frequency to vibrationally destabilize Protons, provided that there is no part of the emitter's structure or nearby atmosphere that is in the beam-path close enough to damage the emitter by triggering excessively-close-range proton decomposition.

Thus, as disclosed above, it is evident that the electromagnetic continuous-wave beam frequency interacting with a target material may be adjusted to disrupt election shells of the target material through ionization or sustained resonant vibration; to disrupt inter-atomic chemical bonds of the target material through sustained resonant vibration; to disrupt proton-neutron bonds of nuclei of the target isotope through sustained resonant vibration; and/or to disrupt inter-quark bonds of protons or neutrons of the target isotope through sustained resonant vibration.

FIG. 8 depicts a flowchart illustrating an exemplary embodiment of a method for remotely-inducing variable-element electro-chemical-nuclear disruption. The flowchart 80 includes inducing a nuclear vibrational decomposition via sustained energy delivery using a laser-like device at an isotope-specific frequency or frequency-pattern that is delivered by a continuous-wave beam to a target material at an intersection point, at 82. Inducing the nuclear vibrational decomposition is performed by creating one or more continuous-wave non-photonic electromagnetic beams by manipulating oscillations of cyclically accelerated trapped ions or charged particles, at 83. Additionally, the one or more continuous-wave non-photonic electromagnetic beams are tuned such that the individual beam or the aggregate multi-beam interference-pattern match a frequency that induces a harmonic resonant vibrational disruption in electron-orbits of a target material, inter-atomic chemical bonds, isotope-specific nuclear structure, and/or inter-quark bonds of the protons or neutrons within a nuclei of the target material, at 84. Furthermore, the one or more continuous-wave non-photonic electromagnetic beams are interested on the target, at 86.

Medical uses of the TCCWEE 30 may include targeted resonance stimulation for any molecule with a sufficiently unique energy signature so as to avoid unintended cross-stimulation. Specifically, most viral, bacterial or fungal infections have a number of unique proteins that can be damaged or overheated to disable or destroy the pathogen. Similarly, most toxins are likely to have a unique resonant energy frequency signature and can either be remotely dismantled or induced to change energy states to facilitate non-damaging chemical reactions allowing for non-destructive metabolic elimination. Some cancer types have been discovered to have unique molecular signatures, but many others have metabolic activity patterns or uptake tendencies that can allow them to be targeted by molecular tagging followed by externally-driven heating or manipulation of the tagged chemicals absorbed by the cancer cells.

Other medical uses can involve non-invasive TCCWEE-interferometry surgery, excision, cauterization, de-adhesion (of prior surgical scar-adhesion-damage), or direct cellular operations manipulation. Direct cellular manipulation would attempt to boost or hamper particular chemical actions, interactions or reactions on an inter-cellular or intra-cellular level. An ideal use for this would be to use manipulated or sensitized stem-cells for regenerative reconstruction with time and position-variable TCCWEE interference patterns stimulating particular reconstructive activity on a sub-millimeter-scale for organ or limb re-growth where each different manipulated stem cell type would have been given a different triggering chemical with unique frequency sensitivity.

Another medical use of the TCCWEE system would be to directly induce and control hypnotic brain states, allowing for non-anesthetic surgery, pain mitigation or management, or direct regional therapeutic manipulation on a micro-regional-scale. This would be accomplished by tuning a dual-TCCWEE system to any of several frequencies that would either trigger or impair neural firing in the specific type of nerve cells desired, then oscillating the amplitude of the TCCWEE intensity to the desired brainwave synchronization pattern, such as a 7 Hz oscillation for a deep hypnotic state, wide-field-targeted on the subject's pre-frontal cortex.

Mineral extraction and purification can be simplified using chemical bond disruption by either progressively removing various types of unwanted substances or by inducing a preferred substance to shear its bonds with the minerals it has shared electrons with. Specific isotopes can be selected for during the purification process by slight frequency adjustments since individual isotopes, particularly of heavy elements, have small differences in their electron absorption and emission frequencies.

Alternately, there is great potential for nuclear structure manipulation by inducing variant energy states in targeted nuclei, either to induce decay or capture to re-stabilize the nuclear shell structure after externally-driven destabilization. Ideally, this would enable creation of the super-heavy elements in or near the high-mass “Island of stability” around atomic mass 290, Z˜110 with no specific limitation on new element creation.

Oppositely, the embodiments illustrated above may be used for useful disposal of nuclear or toxic waste without byproducts, such that harmful isotopes can either be selectively disintegrated or have their nuclear structure converted into safe states, while harmful chemicals can be de-constructed and rendered inert without extensive infrastructure or additional exotic chemistry.

Serializing these two previous concepts leads to a system of elemental transformation. This can then be combined with the use of three or more TCCWEE's in interference to create atomic-scale ultra-small regions of targeted ionization on an object or surface immediately prior to delivering a desired atom to the appropriately ionized location, such as by using continuous-wave interference patterns to steer an ionized traveling-atom to its destination. This chain of elemental-transformation, targeted ionization and positional manipulation will thus allow for atomic-scale object fabrication and assembly from arbitrary input materials into arbitrary output materials. For example, input silicate rock. Then nuclear-disrupt the silicate rock and re-assemble in a mass-energy-mass conversion into iron and carbon. Then use atomic-guided re-assembly to fabricate an engine part or the complete engine, much like how 3D stereo-lithography is performed.

The extreme controllability and tuneability of the emission 21 from the TCCWEE 30 may allow for improvements over lasers for use in communications, whether used directly in a pulsed state or used to drive fiber-optic lasing.

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc., do not denote any order or importance, but rather the terms first, second, etc., are used to distinguish one element from another.

What is claimed is:

1. A system for remotely-inducing variable-element electro-chemical-nuclear disruption, the system comprising:
an energy delivery device that emits a frequency-adjustable electromagnetic non-photonic continuous-wave beam; and
a target area located a distance from the energy delivery device with which the continuous-wave electromagnetic beam interacts;
wherein the energy delivery device accelerates one or more charged particles or ions within the energy delivery device as a charge antenna.

2. The system according to claim 1, wherein the energy delivery device further comprises opposing containment fields for rapidly vibrating one or more particles or ions isolated therein, forming the charge antenna.

3. The system according to claim 1, wherein the energy delivery device further comprises adjacent charge-plates for rapidly vibrating one or more particles or ions of the charge antenna.

4. The system according to claim 1, wherein the energy delivery device further comprises open faces defined by wire-wound coils with independent oscillation control over each pair of opposing faces.

5. The system according to claim 1, wherein the energy delivery device further comprises six sides or more polyhedral compound structure having opposing faces.

6. The system according to claim 1, wherein the energy delivery device further comprises one or more independently controllable charge grids to longitudinally bias and steer cyclical movements of the charge antenna.

7. The system according to claim 1, wherein the energy delivery device further comprises two output axis containment field generators facing each other, two vertical axis containment field generators facing each other, and two lateral axis containment field generators facing each other.

8. The system according to claim 1, wherein the energy delivery device is positioned within a vacuum chamber.

9. The system according to claim 1, further comprising a thermal energy transfer system and a target material wherein the target area comprises the target material contained within a thermal energy transfer system.

10. The system according to claim 1, further comprising a target material and a radiation-to-energy conversion pathway or a chamber wherein the target area comprises the target material contained within the radiation-to-electricity conversion pathway or the chamber.

11. The system according to claim 1, further comprising a target material and a medium for a thermal expansion propulsion system wherein the target area comprises the target material within the medium for a thermal expansion propulsion system.

12. The system according to claim 1, wherein a plurality of energy delivery devices each emit a frequency-adjustable electromagnetic non-photonic continuous-wave beam that intersect at an intersection point within the target area.

13. The system according to claim 12, wherein an electromagnetic interference pattern created at the intersection point of the plurality of beams aggregate to an intended resonant frequency pattern.

14. The system according to claim 1, wherein a frequency of the electromagnetic continuous-wave beam interacting with a target material within the target area is adjusted to disrupt electron shells of the target material through ionization or sustained resonant vibration.

15. The system according to claim 1, wherein a frequency of the electromagnetic continuous-wave beam interacting with a target material within the target area is adjusted to disrupt inter-atomic chemical bonds of the target material through sustained resonant vibration.

16. The system according to claim 1, wherein a frequency of the electromagnetic continuous-wave beam interacting with a target isotope within the target area is adjusted to disrupt proton-neutron bonds of nuclei of the target isotope through sustained resonant vibration.

17. The system according to claim 1, wherein a frequency of the electromagnetic continuous-wave beam interacting with a target isotope within the target area is adjusted to disrupt inter-quark bonds of protons or neutrons of the target isotope through sustained resonant vibration.

18. A method for remotely-inducing variable-element electro-chemical-nuclear disruption, the method comprising inducing a nuclear vibrational decomposition via sustained energy delivery using a laser-like device at an isotope-specific frequency or frequency-pattern that is delivered by a continuous-wave beam to a target material at an intersection point.

19. The method according to claim 18, wherein inducing further comprising:
creating one or more continuous-wave non-photonic electromagnetic beams by manipulating oscillations of cyclically accelerated trapped ions or charged particles; and
tuning the one or more continuous-wave non-photonic electromagnetic beams such that an individual beam or an aggregate multi-beam interference-pattern match a frequency that induces a harmonic resonant vibrational disruption in electron-orbits of a target material, inter-atomic chemical bonds, isotope-specific nuclear structure, and/or inter-quark bonds of the protons or neutrons within a nuclei of the target material.

20. The method according to 18, further comprising intersecting the one or more continuous-wave non-photonic electromagnetic beams upon the target material.
